(19) United States
(12) Patent Application Publication
(10) Pub. No.: US 2026/0061370 A1
(43) Pub. Date: Mar. 5, 2026

(54) METHANE PURIFICATION APPARATUS

(71) Applicant: ISUZU MOTORS LIMITED, Yokohama-shi (JP)

(72) Inventor: Naoya ISHIKAWA, Fujisawa-shi (JP)

(21) Appl. No.: 19/307,069

(22) Filed: Aug. 22, 2025

(30) Foreign Application Priority Data
Sep. 4, 2024 (JP) 2024-152453

(51) Int. Cl. B01D 53/88; B01D 53/86; B01D 53/90; B01D 53/94

(52) U.S. Cl. CPC B01D 53/885; B01D 53/8668; B01D 53/8696; B01D 53/90; B01D 53/9495; B01D 2251/104; B01D 2257/7025; B01D 2258/01; B01D 2258/06; B01D 2259/65; B01D 2259/806

(57) ABSTRACT

A methane purification apparatus includes: a flow path through which a first gas containing methane flows; an ozone supply unit that supplies ozone to the first gas; a catalyst that decomposes methane contained in a second gas containing the first gas flowing through the flow path and ozone supplied by the ozone supply unit; and a microwave output unit that outputs microwaves around the catalyst in the flow path.

### CROSS-REFERENCE TO RELATED APPLICATIONS

The present application claims priority to Japanese Patent Application number 2024-152453, filed on Sep. 4, 2024, contents of which are incorporated herein by reference in its entirety.

### BACKGROUND OF THE INVENTION

The present disclosure relates to a methane purification apparatus. Conventional pollutant treatment methods remove methane contained in a gas containing methane and ozone and having a temperature within a predetermined range by bringing the gas into contact with a catalyst and oxidizing the methane with ozone (for example, Japanese Unexamined Patent Application Publication No. 2021-505376).

When methane is decomposed by reacting with ozone on a catalyst, water and carbon dioxide are generated, and the generated water adheres to the catalyst and blocks a region on the catalyst where methane and ozone come into contact and react, thereby making it more difficult for methane and ozone to react on the catalyst.

### BRIEF SUMMARY OF THE INVENTION

The present disclosure has been made in view of these points, and it aims to allow methane and ozone to react while removing water adhering to a catalyst.

A methane purification device according to an aspect of the present disclosure includes: a flow path through which a first gas containing methane flows; an ozone supply unit that supplies ozone to the first gas; a catalyst that decomposes the methane contained in a second gas containing the first gas flowing through the flow path and the ozone supplied by the ozone supply unit; and a microwave output unit that outputs microwaves around the catalyst in the flow path.

### BRIEF DESCRIPTION OF THE DRAWINGS

FIG. 1 is a diagram showing an outline of a methane purification apparatus 1 according to the present embodiment.

FIG. 2 is a diagram showing an operation of an ozone supply unit 22 and a microwave output unit 29.

FIG. 3 is a diagram showing an example of a processing sequence in the methane purification apparatus 1.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### <Overview of a Methane Purification Apparatus 1>

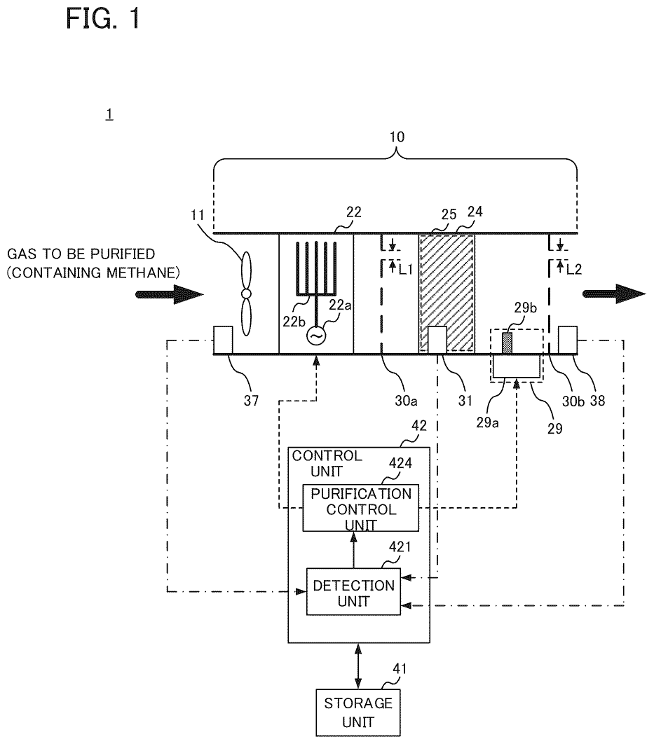

FIG. 1 is a diagram showing an overview of a methane purification apparatus 1 according to the present embodiment. The methane purification apparatus 1 illustrated in FIG. 1 includes a flow path 10, an intake unit 11, an ozone supply unit 22, a methane decomposition unit 24, a microwave output unit 29, a first shielding plate 30a, a second shielding plate 30b, a temperature sensor 31, a methane concentration sensor 37, a methane concentration sensor 38, a storage unit 41, and a control unit 42. The methane purification apparatus 1 is an apparatus that decomposes methane contained in air to generate water and carbon dioxide.

The flow path 10 is a flow path through which air containing methane (hereinafter referred to as “first gas”) flows. The intake unit 11 is, for example, an intake fan, and draws the first gas into the flow path 10 from outside the flow path 10.

The ozone supply unit 22 is provided downstream of the intake unit 11 and upstream of the methane decomposition unit 24 in the flow path 10, and supplies ozone to the first gas drawn in by the intake unit 11. The ozone supply unit 22 includes, for example, an AC power source 22a and electrodes 22b covered with a dielectric such as glass, and performs a process of generating ozone by applying an AC voltage to the electrodes 22b by the AC power source 22a (so-called silent discharge method). The ozone supply unit 22 may generate ozone by performing a process in which discharge occurs on the surface of a dielectric that covers the electrodes (so-called, creeping discharge method), a process in which water is electrolyzed (so-called, electrolysis method), or a process in which ultraviolet light is irradiated onto the first gas (so-called, ultraviolet lamp method). By supplying the generated ozone to the first gas, the ozone supply unit 22 generates a second gas containing the first gas and ozone.

The methane decomposition unit 24 is provided downstream of the ozone supply unit 22 in the flow path 10, and houses a catalyst 25. The methane decomposition unit 24 generates water and carbon dioxide by decomposing methane, for example, by causing ozone and methane contained in the second gas to react on the catalyst 25.

The catalyst 25 decomposes methane contained in the second gas, which contains the first gas flowing through the flow path 10 and ozone supplied by the ozone supply unit 22. The catalyst 25 includes a carrier having a predetermined structure and a coating layer supported on the surface of the carrier. The predetermined structure is, for example, a honeycomb structure, a corrugated structure, a mesh structure, or a porous structure. The material of the carrier is, for example, cordierite, silicon carbide, glass wool, or glass fiber. The material of the carrier is preferably one that allows microwaves to pass through and is non-conductive, but is not limited to such materials. The coating layer includes, for example, zeolite, iron ion-exchanged zeolite, or cobalt ion-exchanged zeolite. The region of the surface of the carrier may include a region that does not support the coating layer.

The microwave output unit 29 is provided downstream of the methane decomposition unit 24 in the flow path 10, and outputs microwaves around the catalyst 25 in the flow path 10. The frequency of the microwaves is a frequency capable of raising the temperature of water adhering to the catalyst 25, and is, for example, 2.4 GHz. The microwave output unit 29 is, for example, a magnetron having a diode-type vacuum tube 29a and an antenna 29b. Electrons orbit around the cathode of the diode-type vacuum tube 29a while rotating due to the Lorentz force, and the resulting energy is output from the antenna 29b as radio waves (microwaves). By operating in this manner, the microwave output unit 29 can raise the temperature of the water generated by decomposing methane and adhering to the catalyst 25, and vaporize the water. As a result, the water adhering to the catalyst 25 is removed.

The first shielding plate 30a is provided upstream of the catalyst 25 and the microwave output unit 29 in the flow path 10, and includes one or more first through portions through which the second gas passes, and blocks microwaves. The first shielding plate 30a is, for example, an expanded metal plate, a decorative metal plate, a punched metal plate, or a metal mesh plate, and includes one or more first through portions having a circular, elliptical, or polygonal shape.

When the first through portion is circular, the first shielding plate 30a includes a first through portion having a diameter equal to or less than a length L1, which is half or less of the wavelength λ of microwaves output by the microwave output unit 29. When the first through portion is elliptical, the first shielding plate 30a includes a first through portion whose side length is the length L1. When the first through portion is polygonal, the first shielding plate 30a includes a first through portion in which one side is the length L1. With the above configuration, the first shielding plate 30a allows the second gas to pass through while preventing microwaves from leaking to the upstream side of the first shielding plate 30a in the flow path 10.

The second shielding plate 30b is provided downstream of the catalyst 25 and the microwave output unit 29 in the flow path 10, includes one or more second through portions through which the second gas passes, and blocks microwaves. The second shielding plate 30b is, for example, an expanded metal plate, a decorative metal plate, a punched metal plate, or a metal mesh plate, and includes one or more second through portions having a circular, elliptical, or polygonal shape.

When the second through portion is circular, the second shielding plate 30b includes a second through portion having a diameter equal to or less than a length L2, which is half the wavelength λ of microwaves output by the microwave output unit 29. When the second through portion is elliptical, the second shielding plate 30b includes a second through portion whose side length is the length L2. When the second through portion is polygonal, the second shielding plate 30b includes a second through portion in which one side is the length L2. With the above configuration, the second shielding plate 30b allows the second gas to pass through while preventing microwaves from leaking to the downstream side of the second shielding plate 30b in the flow path 10. The length L1 and length L2 may be the same or different.

The temperature sensor 31 is a sensor for detecting the temperature of the second gas flowing through the methane decomposition unit 24, which is provided on the inner wall surface of the methane decomposition unit 24, and is, for example, a thermistor or a thermocouple. The methane concentration sensor 37 is a sensor for detecting the concentration of methane contained in the first gas, which is provided upstream of the intake unit 11 in the flow path 10. The methane concentration sensor 38 is a sensor for detecting the concentration of methane contained in the second gas, which is provided downstream of the catalyst 25 in the flow path 10. As an example, the methane concentration sensor 37 and the methane concentration sensor 38 detect the methane concentration by (i) irradiating the flow path 10 with light having a predetermined wavelength (e.g., 1653 nm), and (ii) detecting a 1f (10 kHz) component and a 2f (20 kHz) component that are proportional to the light intensity.

The storage unit 41 includes, for example, a storage medium such as a ROM (Read Only Memory), a RAM (Random Access Memory), a hard disk drive (HDD), or a solid state drive (SSD). The storage unit 41 stores programs executed by the control unit 42 and various types of information for decomposing methane contained in the second gas.

The control unit 42 includes a processor such as a CPU (Central Processing Unit). The control unit 42 causes the AC power source 22a to apply a voltage, thereby causing the ozone supply unit 22 to supply ozone. The control unit 42 causes the microwave output unit 29 to output microwaves, thereby raising the temperature of the water adhering to the catalyst 25. The control unit 42 may be configured by a single processor, or may be configured by a plurality of processors or a combination of one or more processors and an electronic circuit.

Since the control unit 42 operates in this manner, the methane purification apparatus 1 can vaporize the water adhering to the catalyst 25 by raising the temperature of microwaves output by the microwave output unit 29. As a result, since the water adhering to the catalyst 25 is reduced, it is possible to suppress a situation in which the reaction between methane and ozone becomes less likely to occur on the catalyst 25 due to the water blocking regions (so-called reaction sites) where the methane and the ozone come into contact on the catalyst 25 and react. Hereinafter, the configuration and operation of the control unit 42 will be described in detail.

### <Configuration of the Control Unit 42.>

As illustrated in FIG. 1, the control unit 42 includes a detection unit 421 and a purification control unit 424. The control unit 42 functions as the detection unit 421 and the purification control unit 424 by executing programs stored in the storage unit 41.

The detection unit 421 detects the temperature of the catalyst 25. For example, the detection unit 421 detects the temperature of the catalyst 25 by acquiring the temperature of the second gas flowing through the methane decomposition unit 24, which is detected by the temperature sensor 31, as the temperature of the catalyst 25. The detection unit 421 detects a first concentration of methane contained in the first gas at an inlet of the flow path 10 and a second concentration of methane contained in the second gas flowing downstream of the catalyst 25 in the flow path 10. The detection unit 421 detects the first concentration and the second concentration by, for example, acquiring the methane concentration detected by the methane concentration sensor 37 as the first concentration and acquiring the methane concentration detected by the methane concentration sensor 38 as the second concentration.

The purification control unit 424 controls the time period in which the ozone supply unit 22 supplies ozone and the time period in which the microwave output unit 29 outputs microwaves. For example, the purification control unit 424 causes the ozone supply unit 22 to supply ozone by applying a voltage to the AC power source 22a, and causes the ozone supply unit 22 to stop the ozone supply by stopping the application of the voltage to the AC power source 22a. For example, the purification control unit 424 causes the antenna 29b to output microwaves by applying a voltage to the diode-type vacuum tube 29a, and stops the output of microwaves from the antenna 29b by stopping the application of the voltage to the diode-type vacuum tube 29a.

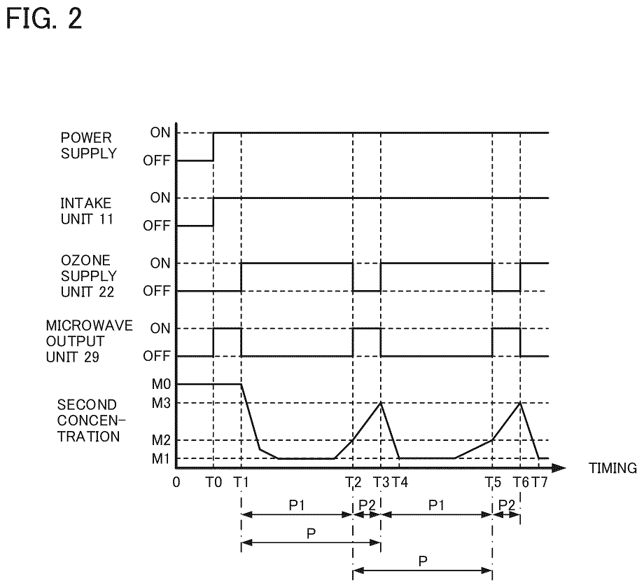

FIG. 2 is a diagram showing the operation of the ozone supply unit 22 and the microwave output unit 29. The horizontal axis in FIG. 2 indicates a timing, and the vertical axis in FIG. 2 indicates “power supply”, “intake unit 11”, “ozone supply unit 22”, “microwave output unit 29”, and “second concentration”. The “power supply” indicates whether or not the power of the methane purification apparatus 1 is turned on. The “intake unit 11”, the “ozone supply unit 22”, and the “microwave output unit 29” each indicate whether they are in an operation state or not. The “second concentration” indicates the second methane concentration detected by the detection unit 421. In the “power supply”, a power-off state “OFF” and a power-on state “ON” are shown. In the “intake unit 11”, the “ozone supply unit 22”, and the “microwave output unit 29”, a stopped state “OFF” and an operating state “ON” are shown.

At a timing T0 shown in FIG. 2, when the methane purification apparatus 1 transitions from a power-off state to a power-on state, the intake unit 11 changes from a stopped state to an operating state, and starts drawing the first gas into the flow path 10. Immediately after the methane purification apparatus 1 is activated (i.e., immediately after the timing T0), the purification control unit 424 causes the microwave output unit 29 to output microwaves. By operating in this manner, the purification control unit 424 can raise the temperature of moisture, contained in air, that has adhered to the catalyst while the methane purification apparatus 1 was turned off, and remove (vaporize) the moisture by causing the microwave output unit 29 to output microwaves. After the moisture is removed from the catalyst 25, the purification control unit 424 can cause methane and ozone to react on the catalyst 25.

Next, after a predetermined time period has elapsed from the timing at which the microwave output unit 29 starts outputting microwaves (i.e., timing T1), the purification control unit 424 causes the microwave output unit 29 to stop outputting microwaves and causes the ozone supply unit 22 to supply ozone. After the timing T1, the purification control unit 424 alternately performs a process in which the ozone supply unit 22 supplies ozone and a process in which the microwave output unit 29 outputs microwaves.

By operating as described above, the purification control unit 424 can supply power to one of the ozone supply unit 22 and the microwave output unit 29. As a result, the methane purification apparatus 1 can reduce power consumption. Furthermore, the purification control unit 424 can cause the ozone supply unit 22 to start supplying ozone immediately after the microwave output unit 29 has removed the water adhering to the catalyst 25, thereby allowing methane and ozone to more readily react on the catalyst 25.

For example, at a timing after the timing T1, the purification control unit 424 causes the ozone supply unit 22 to perform the process in which the ozone supply unit 22 supplies ozone at a predetermined cycle P for a predetermined time period P1. The predetermined cycle P and the time period P1 are values corresponding to the amount of water that may adhere to the catalyst 25, and are calculated on the basis of, for example, the volume of the flow path 10, the volume of the catalyst 25, and a target value of the amount of methane purified by the methane purification apparatus 1. These values are stored in the storage unit 41. As illustrated in FIG. 2, the purification control unit 424 causes the ozone supply unit 22 to supply ozone during the time period P1 from the timing T1 to a timing T2, for example. Next, the purification control unit 424 causes the ozone supply unit 22 to supply ozone during the time period P1 from a timing T3 to a timing T5, where T3 is a point in time after the predetermined cycle P has elapsed from the timing T1.

By operating as described above, the purification control unit 424 can cause the microwave output unit 29 to output microwaves in the time period P2 during which the ozone supply unit 22 has stopped supplying ozone. As a result, the purification control unit 424 can vaporize the water generated by decomposing methane and adhering to the catalyst 25.

For example, the purification control unit 424 causes the microwave output unit 29 to perform a process of outputting microwaves at the predetermined cycle P for a predetermined time period P2. The predetermined time period P2 is a value corresponding to the amount of water that may adhere to the catalyst 25, and is calculated on the basis of, for example, the volume of the flow path 10, the volume of the catalyst 25, and the target value of the amount of methane purified by the methane purification apparatus 1. The value is stored in the storage unit 41. As illustrated in FIG. 2, for example, the purification control unit 424 causes the microwave output unit 29 to output microwaves in a time period P2 from the timing T2 to the timing T3. Next, the purification control unit 424 causes the microwave output unit 29 to output microwaves in a time period P2 from the timing T5 to a timing T6, where T5 is a point in time after the predetermined cycle P has elapsed from the timing T2.

By operating as described above, the purification control unit 424 can vaporize the water adhering to the catalyst 25 during the time period P2 shown in FIG. 2. As a result, at the timing immediately after the time period P2 has elapsed, since the water adhering to the reaction sites has been removed, methane and ozone can more readily react, and the purification control unit 424 can reduce the increased second concentration at regular intervals. Specifically, the second concentration indicating a concentration M2 at the timing T2 and the timing T5 can be decreased to a concentration M1 at a timing T4 and a timing T7.

The amount of water adhering to the catalyst 25 increases in a short time as the amount of methane contained in the second gas increases. As a result, the greater the amount of methane contained in the second gas, the more difficult it becomes for methane and ozone to react on the catalyst 25 in a short time, and thus the second concentration increases. Therefore, in a case where the purification control unit 424 causes the microwave output unit 29 to output microwaves at the predetermined cycle P, the greater the amount of methane contained in the second gas, the higher the probability that the timing for outputting microwaves will be inappropriate, and thus the second concentration is more likely to increase.

Therefore, the purification control unit 424 may cause the microwave output unit 29 to output microwaves on condition that (i) a methane purification rate based on the first concentration and the second concentration detected by the detection unit 421 is less than a predetermined purification rate or (ii) the second concentration is equal to or more than the predetermined concentration. The predetermined purification rate is, for example, a purification rate corresponding to the target value of the amount of methane purified by the methane purification apparatus 1, and is stored in the storage unit 41. The predetermined concentration is, for example, a concentration corresponding to the target value of the amount of methane purified by the methane purification apparatus 1, and is stored in the storage unit 41.

For example, the purification control unit 424 causes the microwave output unit 29 to output microwaves on condition that the second concentration is equal to or higher than the concentration M2 illustrated in FIG. 2. For example, the purification control unit 424 calculates a division value obtained by dividing the second concentration by the first concentration as the methane purification rate, and causes the microwave output unit 29 to output microwaves when the division value is less than the predetermined purification rate. By operating in this manner, the purification control unit 424 can remove (vaporize) water adhering to the catalyst 25 by outputting microwaves in response to an increase in the methane concentration, thereby allowing methane and ozone to more readily react on the catalyst 25. As a result, the purification control unit 424 can output microwaves at an appropriate timing and suppress an increase in the second concentration.

Since water vaporizes at approximately 100° C. (99.974° C.) at 1 atm, even if microwaves corresponding to a temperature exceeding 100° C. are output, the amount of water vaporized does not readily increase. Therefore, when the temperature of the catalyst 25 detected by the detection unit 421 reaches a predetermined temperature after the purification control unit 424 has caused the microwave output unit 29 to start outputting microwaves, the purification control unit 424 may cause the microwave output unit 29 to stop outputting microwaves. The predetermined temperature is, for example, 100° C. By operating in this manner, the purification control unit 424 can appropriately control the time period in which the microwave output unit 29 outputs microwaves.

Furthermore, the purification control unit 424 may determine the predetermined temperature on the basis of the atmospheric pressure in the flow path 10. The purification control unit 424 acquires, for example, the atmospheric pressure detected by an atmospheric pressure sensor (not shown) provided inside the flow path 10. After acquiring the internal atmospheric pressure of the flow path 10, by referencing a table stored in the storage unit 41 that indicates the atmospheric pressure (vapor pressure) corresponding to the temperature, the purification control unit 424 identifies the temperature corresponding to the internal atmospheric pressure acquired by the atmospheric pressure sensor and determines the identified temperature as the predetermined temperature. By operating in this manner, the purification control unit 424 can improve the accuracy in determining the predetermined temperature, and thus can more appropriately control the time period in which the microwave output unit 29 outputs microwaves.

When the purification control unit 424 determines the output timing of microwaves on the basis of the methane concentration or determines the duration of microwave output on the basis of the temperature of the catalyst 25, it is possible that there is a period of time during which both the ozone supply unit 22 and the microwave output unit 29 operate. In this case, the methane purification apparatus 1 consumes a large amount of power during the period in which both the ozone supply unit 22 and the microwave output unit 29 operate. Therefore, when the purification control unit 424 causes the microwave output unit 29 to output microwaves during a time period in which it is also causing the ozone supply unit 22 to supply ozone, the purification control unit 424 may reduce the output of microwaves.

For example, when the purification control unit 424 causes the microwave output unit 29 to output microwaves in a state where the ozone supply unit 22 does not supply ozone (that is, a voltage is not applied to the AC power source 22a), the purification control unit 424 applies a first voltage to the diode-type vacuum tube 29a. On the other hand, when the purification control unit 424 causes the microwave output unit 29 to output microwaves in a state where the ozone supply unit 22 supplies ozone (that is, a voltage is applied to the AC power source 22a), the purification control unit 424 applies a second voltage that is lower than the first voltage to the diode-type vacuum tube 29a. By operating in this manner, the purification control unit 424 can prevent an increase in power consumption of the methane purification apparatus 1.

### <Process Sequence in the Methane Purification Apparatus 1>

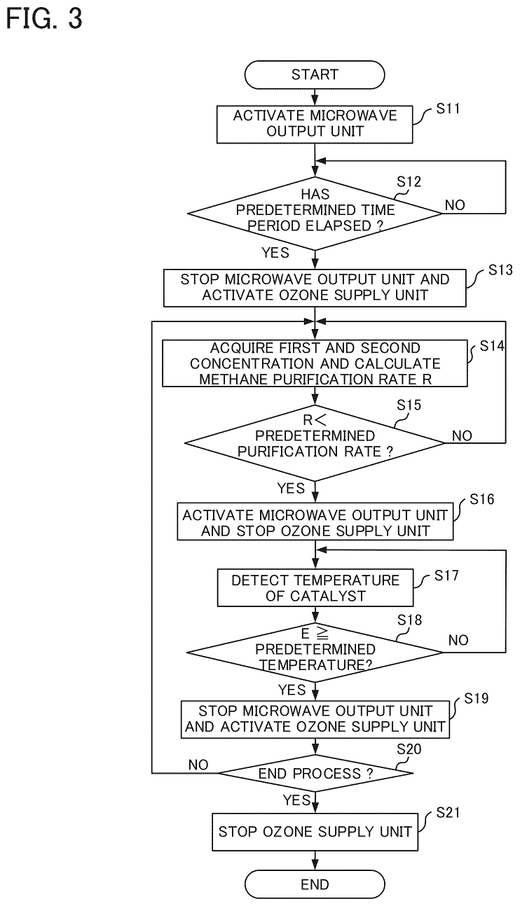

FIG. 3 is a diagram showing an example of a processing sequence in the methane purification apparatus 1. The processing sequence illustrated in FIG. 3 is a processing sequence for determining a timing at which and a time period in which the microwave output unit 29 outputs microwaves on the basis of the methane concentration and the temperature of the catalyst 25. The processing sequence illustrated in FIG. 3 starts at a timing (for example, the timing T0 illustrated in FIG. 2) at which the methane purification apparatus 1 transitions from a power-off state to a power-on state.

The purification control unit 424 activates the microwave output unit 29 to start outputting microwaves in order to remove water that has adhered to the catalyst 25 while the methane purification apparatus 1 is in a stopped state (Step S11). If a predetermined time period has not elapsed (NO in step S12), the purification control unit 424 maintains the microwave output unit 29 in the activated state. If the predetermined time period has elapsed (YES in step S12), the purification control unit 424 stops the microwave output unit 29 from outputting microwaves and activates the ozone supply unit 22 to start supplying ozone (step S13).

The purification control unit 424 acquires a first concentration and a second concentration detected by the detection unit 421, and calculates a divided value obtained by dividing the second concentration by the first concentration as the methane purification rate R (Step S14). If the methane purification rate R is equal to or higher than a predetermined purification rate (NO in step S15), the purification control unit 424 returns to the process of step S14. If the methane purification rate R is less than the predetermined purification rate (YES in step S15), the purification control unit 424 activates the microwave output unit 29 to start outputting microwaves and stops the ozone supply unit 22 from supplying ozone (step S16).

The detection unit 421 detects a temperature E of the catalyst 25 (step S17). If the temperature E is lower than a predetermined temperature (NO in step S18), the purification control unit 424 returns to the process of step S17. If the temperature E is equal to or higher than the predetermined temperature (YES in step S18), the purification control unit 424 stops the microwave output unit 29 from outputting microwaves, and activates the ozone supply unit 22 to start suppling ozone (step S19). If the methane purification apparatus 1 does not receive an operation to end the process (NO in step S20), the methane purification apparatus 1 repeats the process from step S14 to step S19. If the methane purification apparatus 1 receives the operation to end the process (YES in step S20), the methane purification apparatus 1 causes the purification control unit 424 to stop the ozone supply unit 22 and ends the process.

### First Modification

In the above description, the operation in which the methane purification apparatus 1 decomposes methane contained in air is exemplified, but the operation is not limited thereto. The methane purification apparatus 1 may decompose methane contained in exhaust gas discharged from equipment or a vehicle installed in a plant. As one example, the methane purification apparatus 1 may be provided in an exhaust passage downstream of an engine included in the vehicle, and may decompose methane contained in exhaust gas of the engine.

### Second Modification

In the above description, a configuration in which the microwave output unit 29 is provided downstream of the methane decomposition unit 24 in the flow path 10 is exemplified, but the configuration is not limited thereto. The microwave output unit 29 may be provided downstream of the first shielding plate 30a and upstream of the methane decomposition unit 24 in the flow path 10.

### Third Modification

In the above description, the operation in which the intake unit 11 starts drawing the first gas into the flow path 10 at the timing when the power of the methane purification apparatus 1 is turned on (e.g., timing T0 shown in FIG. 2) is exemplified, but the operation is not limited thereto. The intake unit 11 may start drawing the first gas into the flow path 10 from the timing (timing T1 shown in FIG. 2) at which the microwave output unit 29, which began outputting microwaves immediately after the power of the methane purification apparatus 1 was turned on, stops outputting microwaves. That is, by causing the microwave output unit 29, which began outputting microwaves after the energization of the methane purification apparatus 1 was started, to stop the output of microwaves, the purification control unit 424 starts drawing the first gas into the flow path 10. By operating in this manner, the methane purification apparatus 1 can prevent a gas with a high methane concentration from being output during the time period from the timing T0 to the timing T1 shown in FIG. 2.

### <Effects of the Methane Purification Apparatus 1>

As described above, the methane purification apparatus 1 includes the flow path 10 through which the first gas containing methane flows, the ozone supply unit 22 that supplies ozone to the first gas, the catalyst 25 that decomposes methane contained in the second gas containing the first gas flowing through the flow path 10 and ozone supplied by the ozone supply unit 22, and the microwave output unit 29 that outputs microwaves around the catalyst 25 in the flow path 10.

With such a configuration, the methane purification apparatus 1 can vaporize water that is generated by decomposing methane and adhering to the catalyst 25 by raising its temperature with microwaves output by the microwave output unit 29. As a result, the methane purification apparatus 1 can decompose methane by causing methane and ozone to react on the catalyst 25 while suppressing the reaction between methane and ozone from becoming difficult due to water adhering to the catalyst 25 blocking the reaction site of the catalyst 25.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A methane purification device comprising:
a flow path through which a first gas containing methane flows;
an ozone supply unit that supplies ozone to the first gas;
a catalyst that decomposes the methane contained in a second gas containing the first gas flowing through the flow path and the ozone supplied by the ozone supply unit; and
a microwave output unit that outputs microwaves around the catalyst in the flow path.

2. The methane purification device according to claim 1, further comprising:
a first shielding plate that is provided upstream of the catalyst and the microwave output unit in the flow path, includes one or more first through portions through which the second gas passes, and blocks the microwaves; and
a second shielding plate that is provided downstream of the catalyst and the microwave output unit in the flow path, includes one or more second through portions through which the second gas passes, and blocks the microwaves.

3. The methane purification device according to claim 2, wherein the first shielding plate includes the first through portion whose side length or diameter is a length that is half or less of a wavelength of the microwaves output by the microwave output unit, and
the second shielding plate includes the second through portion whose side length or diameter is a length that is equal to or less than half of the wavelength of the microwaves output by the microwave output unit.

4. The methane purification device according to claim 1, further comprising:
a purification control unit that controls a time period in which the ozone supply unit supplies the ozone and a time period in which the microwave output unit outputs the microwaves.

5. The methane purification device according to claim 4, wherein the purification control unit causes the microwave output unit to output the microwaves immediately after the methane purification apparatus is activated, and causes the ozone supply unit to supply the ozone after a predetermined time period has elapsed from a timing at which the microwave output unit starts outputting the microwaves.

6. The methane purification device according to claim 4, further comprising:
a detection unit that detects a first concentration of the methane contained in the first gas at an inlet of the flow path and a second concentration of the methane contained in the second gas flowing downstream of the catalyst in the flow path, wherein the purification control unit causes the microwave output unit to output the microwaves on condition that (i) a methane purification rate based on the first concentration and the second concentration is less than a predetermined purification rate or (ii) the second concentration is equal to or more than the predetermined concentration.

7. The methane purification device according to claim 4, further comprising:
a detection unit that detects a temperature of the catalyst, wherein the purification control unit causes the microwave output unit to stop the output of the microwaves when the temperature of the catalyst reaches a predetermined temperature after the purification control unit 424 has caused the microwave output unit to start outputting the microwaves.

8. The methane purification device according to claim 4, wherein the purification control unit alternately performs a process in which the ozone supply unit supplies the ozone and a process in which the microwave output unit outputs the microwaves.

9. The methane purification device according to claim 4, wherein the purification control unit reduces the output of the microwaves when the purification control unit causes the microwave output unit to output the microwaves during a time period in which the purification control unit is causing the ozone supply unit to supply the ozone.

10. The methane purification device according to claim 7, wherein, after acquiring an internal atmospheric pressure of the flow path, the purification control unit identifies a temperature corresponding to the atmospheric pressure by referencing a table stored in a storage unit that indicates an atmospheric pressure corresponding to the temperature, and determines the temperature as the predetermined temperature.

11. The methane purification device according to claim 4, wherein the purification control unit starts drawing the first gas into the flow path, by causing the microwave output unit which began outputting the microwaves after energization of the methane purification apparatus was started, to stop the output of the microwaves.
